(19) United States
(12) Patent Application Publication
(10) Pub. No.: US 2026/0300107 A1
(43) Pub. Date: Oct. 1, 2026

(54) DATA BACKUP METHODS AND SYSTEMS

(71) Applicant: Atlassian Pty Ltd., Sydney (AU)

(72) Inventors: Alex Grach, Bothell, WA (US); Yash Sharma, Sydney (AU); David Connard, Sydney (AU); Navid Harandi, Sydney (AU); Adam Petrovic, Sydney (AU); Yasara Dissanayake, Melbourne (AU)

(21) Appl. No.: 19/096,442

(22) Filed: Mar. 31, 2025

(51) Int. Cl. G06F 11/14

(52) U.S. Cl. CPC G06F 11/1469; G06F 11/1451; G06F 11/1464

(57) ABSTRACT

Methods and systems for creating and restoring data backups. The methods and systems provide a backup solution by creating backup snapshots. These snapshots are designed to store object references of data objects associated with the backup instead of full object binaries. An object reference is a metadata record pointing to a specific version of a data object (i.e., the version of the data object at a specific time—e.g., at the time when backup is requested). As such, the backup snapshot captures the state of data objects at the time the snapshot is generated, and these backup snapshots can then be used to restore the data objects.

### TECHNICAL FIELD

Aspects of the present disclosure are directed systems and methods for data backup and recovery and more particular to efficient methods of backup and recovery from cloud storage applications.

### BACKGROUND

Data loss can be a significant challenge for organizations of all sizes, occurring due to a variety of reasons such as hardware failures, software errors, human error, and malicious attacks. Efficient and flexible data backup and recovery systems are essential for ensuring that data can be quickly restored, minimizing downtime and data loss.

Traditionally, data backups have been complex and resource-intensive. As the volume of data continues to grow, creating comprehensive data backups becomes increasingly costly, time-consuming and resource-intensive. The sheer quantity of data that needs to be backed up, along with the need to maintain multiple backup copies for redundancy and compliance purposes, can result in significant storage and infrastructure requirements.

### SUMMARY

Described herein is a method for generating a backup, the method includes: receiving a request to backup a set of data objects, the set of data objects including at least a first data object and a second data object; generating object reference identifiers for the set of data objects, wherein generating the object reference identifiers includes: determining a first object identifier of the first data object in an object store where the first data object is stored; retrieving metadata associated with the first data object based on the first object identifier; generating a first object reference using the first object identifier and the metadata associated with the first data object; determining a second object identifier of the second data object in the object store where the second data object is stored; retrieving metadata associated with the second data object based on the second object identifier; generating a second object reference using the second object identifier and the metadata associated with the second data object; storing a location of the first and second data objects in the object store along with the first object reference and the second object reference in a backup file; and communicating the backup file to a client application associated with the backup request.

Also described herein is a computer implemented method for restoring a backup. The method includes: receiving a request to restore a backup at a target site, the request comprising a backup file, wherein the backup file includes at least a first object reference and a second object reference associated with first and second data objects to be restored, and a source location of the first and second data objects; restoring the first data object at a target location in an object store that is associated with the target site, wherein the restoring includes: creating a first object identifier based on the first object reference; and creating the first data object with the first object identifier at the target location; restoring the second data object at the target location in the object store, wherein the restoring includes: creating a second object identifier based on the second object reference; and creating the second data object with the second object identifier at the target location.

Further described herein are computer processing systems including one or more computer processing units; and a non-transitory computer-readable medium storing instructions which, when executed by the one or more computer processing units, cause the one or more computer processing units to perform the computer-implemented methods described above.

Also described herein is a non-transitory storage storing instructions executable by one or more computer processing units to cause the one or more computer processing units to perform the methods described above.

### BRIEF DESCRIPTION OF THE DRAWINGS

In the drawings:

FIG. 1 is a block diagram of a networked environment in which various features of the present disclosure may be implemented.

FIG. 2 is a diagram depicting a computer processing system.

FIG. 3 is a flowchart illustrating an example method for creating a backup snapshot according to aspects of the present disclosure.

FIG. 4 is a flowchart illustrating an example method for restoring a backup snapshot according to aspects of the present disclosure.

FIG. 5 is a flowchart illustrating another example method for restoring a backup snapshot according to aspects of the present disclosure.

While the description is amenable to various modifications and alternative forms, specific embodiments are shown by way of example in the drawings and are described in detail. It should be understood, however, that the drawings and detailed description are not intended to limit the invention to the particular form disclosed. The intention is to cover all modifications, equivalents, and alternatives falling within the scope of the present invention as defined by the appended claims.

### DETAILED DESCRIPTION

### Overview

In the following description numerous specific details are set forth in order to provide a thorough understanding of the present invention. It will be apparent, however, that the present invention may be practiced without these specific details. In some instances, well-known structures and devices are shown in block diagram form in order to avoid unnecessary obscuring.

The present disclosure is generally related to systems and methods for creating and restoring data backups. As described above, data backups are integral to computer systems. Typically, data backups involve the time-consuming and resource intensive process of downloading and then uploading large volumes of data to a secondary storage device such as an external hard drive or cloud-based storage. This conventional backup approach can be costly in terms of resource utilization and may not be scalable due to the storage requirements and the network bandwidth consumed during ingress and egress when copying data.

The methods and systems disclosed herein provide a backup solution centred around creating backup snapshots. These snapshots are designed to store object references of the data objects associated with the backup instead of full object binaries. Object binaries are digital representations of data, such as files, or other digital content, that can be stored. As referred to herein, an object reference is a metadata record pointing to a specific version of a data object (i.e., the version of the data object at a specific time—e.g., at the time when backup is requested). As such, the backup snapshot captures the state of data objects at the time the snapshot is generated.

The snapshot backup system disclosed herein provides several advantages including accelerating the backup and restoration processes as large volumes of data do not need to be transferred. The system also provides significant computing resource and network bandwidth improvements as full binary objects are not downloaded, uploaded or copied, thereby reducing the strain on computer processing power during backup and/or restoration.

It will be appreciated that the present disclosure's snapshot-based backup approach is not intended to completely replace traditional full backups, but rather to serve as a more efficient intermediate backup mechanism between comprehensive backup operations. As an example, an organization may perform full object binary backups once a month, but may create backup snapshots according to the methods and systems described herein daily.

It will be appreciated that backup snapshots can be created for any type of data that requires backup. In one example, backup snapshots may be used to backup an instance of a work/project management application such as Atlassian's Jira® or an instance of a team workspace application such as Atlassian's Confluence®. Generally speaking, such instances may have a plurality of data objects. Each of these data objects may be associated with data, defining each data object. Each data object may also be updated and edited and therefore may be associated with a plurality of different versions. The backup snapshots may be used to capture and store object references to these data objects.

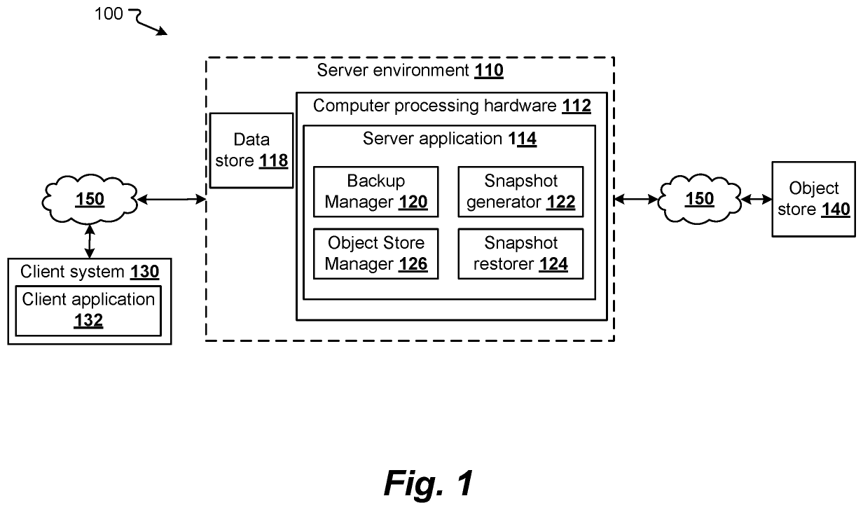

These and other aspects of the present disclosure will be described in detail in the following sections with reference to FIGS. 1-5.

### System Overview

FIG. 1 is a diagram depicting a networked environment 100 in which various features of the present disclosure may be implemented.

Networked environment 100 includes a server environment 110, a client system 130, and an object store 140, which communicate via one or more communications networks 150 (e.g. the Internet).

Generally speaking, the server environment 110 includes computer processing hardware 112 (discussed below) on which applications that provide server-side functionality to client applications such as client application 132 (described below) execute. It further includes a data store 118.

The computer processing hardware includes a server application 114, which executes to provide a client application endpoint that is accessible over communications network 150. For example, where server application 114 serves web browser client applications the server application 114 is a web server which receives and responds (for example) to HTTP requests. Where server application 114 serves native client applications, server application 114 is an application server configured to receive, process, and respond to specifically defined API calls received from those client applications. The server environment 110 may include one or more web server applications and/or one or more application server applications allowing it to interact with both web and native client applications.

In the present example, the server application 114 (and/or other applications of server environment 110) facilitates various functions related to the snapshot backup system. The server application 114 (and/or other applications) may also facilitate additional, related functions such as user account creation and management, user group creation and management, user and user group permission management, user authentication, and/or other server-side functions.

To perform the particular operations described herein, the server application 114 includes a backup manager 120, a snapshot generator 122, a snapshot restorer 124 and an object store manager 126. The backup manager 120 is configured to orchestrate or manage some of the operations disclosed herein. In particular, the backup manager 120 is configured to receive data storage and/or data retrieval requests. It is also configured to process these requests and, where necessary, communicate responses back for such requests indicating the outcome of the requests. Such requests may be received from another module of the server application 114, other server environment applications, and/or (in some instances) directly from client applications, such as client application 132. The backup manager 120, is also configured to communicate and initialise the processes of creating a backup snapshot with snapshot generator 122 and restoring data object from a backup snapshot with the snapshot restorer 124.

The snapshot generator 122 performs tasks related to creating backup snapshots. This may include receiving a request to generate a backup snapshot from the backup manager 120, determining data objects associated with a particular backup request, retrieving necessary information from the object store manager 126 and data store 118, and generating backup snapshots.

The snapshot restorer 124 receives and processes requests to retrieve and restore data object from backup snapshots. To this end, the snapshot restorer 124 may be configured to receive and restore requests from the backup manager 120, and cause data objects to be copied from a source location, e.g., in the object store 140, to be stored at a target location, e.g., in the object store 140.

The object store manager 126 executes to receive and process requests to persistently store and retrieve data relevant to the operations performed/services provided by the server application 114. For instance, the object store manager 126 may be configured to store and retrieve data objects for backup from the object store 140. The object store manager 126 may, for example, be a relation database management application or an alternative application for storing and retrieving data from the object store 140.

Data store 118 and object store 140 may be any appropriate data storage device (or set of devices), for example one or more non-transitory computer readable storage devices such as hard disks, solid state drives, tape drives, alternative computer readable storage devices or cloud storage solutions.

The data relevant to the operations performed/services provided by the server environment 110 is stored in data store 118. The data may include, for example, user account data and/or other data relevant to the operation of the server environment 110.

In addition, the data store 118 includes information about the data objects maintained by the server environment 110. For example, if the server environment is a project management system, the data store 118 maintains information about the boards/workspaces maintained by the project management system for its tenants. For each board/workspace, it also maintains the identifiers of the data objects (e.g., mediaIDs) in the board/workspace.

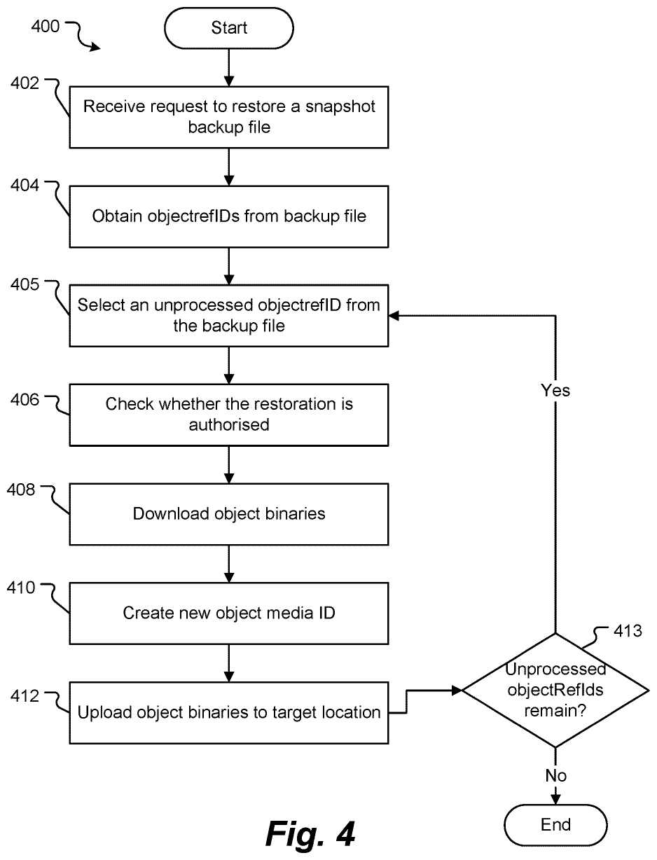

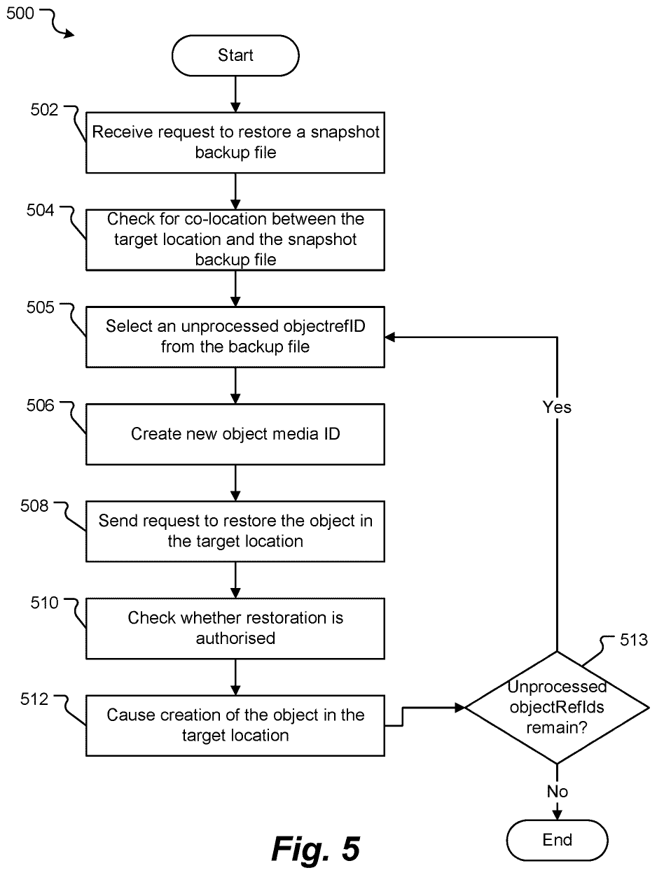

In some embodiments, the data store 118 also maintains authorization information associated with data that is to be backed-up. This authorization information is utilized for restoring backups as will be described with reference to FIGS. 4 and 5. For example, the data store 118 may include organisation and/or tenant ID data.

Data storage 118 also stores information regarding the location of object binaries in the object store 140. For example, it may store partition identifiers and shard identifiers of the locations where data objects maintained by the server application 114 are stored in the object store 140.

As described previously, the object store 140 is a cloud storage service that stores information related to data objects—e.g., it may store object binaries, object metadata, etc, for objects maintained by the server environment 110. The object store 140 may also store such information for data maintained by other server environments. Object store 140 may be a scalable storage server based on object storage technology. In one example, object store may be a cloud storage service such as Amazon's S3.

The object store manager 126 communicates with the object store 140 through network 150, to manage the storage and retrieval of data objects. In the present example, the object store 140 is used as the central repository to store the full binary data of objects, in addition to metadata and other information about data objects. Object store typically is operated across various hardware resources—e.g., server systems and memory databases. Different instances or servers in the object store 140 are referred to as shards whereas different buckets within a particular instance or server are referred to as partitions. The specific location of data corresponding to a given instance or application can therefore be identified based on the unique identifiers of the shard and partition the data is stored in.

Although the object store 140 is depicted as an independent system in network environment 100, in some cases, the object store 140 may be implemented as a part of server environment 110.

While a single data store 118 and object store 140 are described, the networked environment 100 may include multiple data stores and/or object stores. For example, one data store 118 may be used for user account data, media data, another for client backup data and so forth. Similarly, object stores provided by different third-party providers may be utilized to store the data objects maintained by the server environment 110.

In some embodiments, the server environment 110 may also include a tenant management application (not shown) that manages tenant data. In some examples, the tenant management application may be used to store information on mapping of a tenant's data to the appropriate data store 118 and object store 140 locations such as the relevant shard and partition IDs.

As noted, the server environment 110 applications run on (or are executed by) computer processing hardware 112. Computer processing hardware 112 includes one or more computer processing systems. The precise number and nature of those systems will depend on the architecture of the server environment 110.

For example, in one implementation each server environment application may run on its own dedicated computer processing system. In an alternative implementation, two or more server environment applications may run on a common/shared computer processing system. In a further alternative implementation, server environment 110 is a scalable environment in which application instances (and the computer processing hardware 112—i.e. the specific computer processing systems required to run those instances) are commissioned and decommissioned according to demand—e.g. in a public or private cloud-type system. In this case, server environment 110 may simultaneously run multiple instances of each application (on one or multiple computer processing systems) as required by client demand. Where server environment 110 is a scalable system, it will include additional applications to those illustrated and described. As one example, the server environment 110 may include a load balancing application which operates to determine demand, direct client traffic to the appropriate server application instance 114 (where multiple server applications 114 have been commissioned), trigger the commissioning of additional server environment applications (and/or computer processing systems to run those applications) if required to meet the current demand, and/or trigger the decommissioning of server environment applications (and computer processing systems) if they are not functioning correctly and/or are not required for current demand.

Communication between the applications and computer processing systems of the server environment 110 may be by any appropriate means, for example direct communication or networked communication over one or more local area networks, wide area networks, and/or public networks (with a secure logical overlay, such as a VPN, if required).

Client system 130 hosts a client application 132 which, when executed by the client system 130, configures the client system 132 to provide client-side functionality/interact with server environment 110 (or, more specifically, the server application 114 and/or other applications provided by the server environment 110). Via the client application 132, and as discussed in detail below, a user can access the various techniques described herein. Via the client application 132, and as discussed in detail below, a user can make use of the various techniques and features described herein.

The client application 132 may be a general web browser application which accesses the server application 114 via an appropriate uniform resource locator (URL) and communicates with the server application 114 via general world-wide-web protocols (e.g. http, https, ftp). Alternatively, the client application 132 may be a native application programmed to communicate with server application 114 using defined application programming interface (API) calls and responses.

A given client system such as 130 may have more than one client application 132 installed and executing thereon. For example, a client system 130 may have a (or multiple) general web browser application(s) and a native client application.

The present disclosure describes various operations that are performed by applications of the server environment 110 and client application 132. Generally speaking, however, operations described as being performed by a particular application (e.g. server application 114) could be performed by (or in conjunction with) one or more alternative applications, and/or operations described as being performed by multiple separate applications could in some instances be performed by a single application.

As described herein, data in embodiments of the present disclosure corresponds to a plurality of data objects. In some examples, the data objects may be documents or media items that are stored in a cloud-based work management application. In other examples, the data objects may be elements such as task or issues managed by project management applications. In any event, data objects include data. In the example of documents or media items, the data objects include the actual contents of the documents/media items along with other information such as formatting information. In the example of tasks/issues, the data objects include data in the form of field-value pairs. For example, a task data object may include a task name field and a corresponding name value, a task assignee field and a corresponding value, a comment field and one or more corresponding comments, etc. The examples above are not intended to limit the data objects to those examples.

Each data object has one or more unique identifiers that are used to identify the data object. In some embodiments, the data object may have two identifier types-a media identifier (media ID) and an object store identifier (object store ID). The media identifier is used by the server environment to identify the data object on client application 132, and the object store identifier is used by the object store to identify the object. In some cases, the same media identifier may be associated with multiple object store identifiers. This may be the case because a user may update a data object multiple times. Each time the user updates the data object and saves the updated data object, the media ID remains the same. However, a new object store identifier may be created each time the data object is updated and this new data object is separately stored to provide version control functionality. In another example, an object with a particular mediaID, when stored in object store 140, may be stored as multiple instances, where each instance of the data object has a different quality (e.g., 480p, 720p). In such cases there may be a different object store IDs for the different formats of the data object but they may associated with the same media ID. Where two or more identifiers exist for a given data object, a relationship between these identifiers (e.g., between a media ID and corresponding object store IDs) is maintained. This relationship may be stored in the form of a relational or lookup table in the data store 118 and/or in the object store 140. The object identifiers may be stored along with additional information such as creation time and/or modification time so that the object store ID associated with the latest version of a data object can be easily determined.

The techniques and operations described herein are performed by one or more computer processing systems.

By way of example, client system 130 may be any computer processing system which is configured (or configurable) by hardware and/or software—e.g. client application 132—to offer client-side functionality. A client system 130 may be a desktop computer, laptop computer, tablet computing device, mobile/smart phone, or other appropriate computer processing system.

Similarly, the applications of server environment 110 are also executed by one or more computer processing systems (the computer processing hardware 112). Server environment computer processing systems will typically be server systems, though again may be any appropriate computer processing systems.

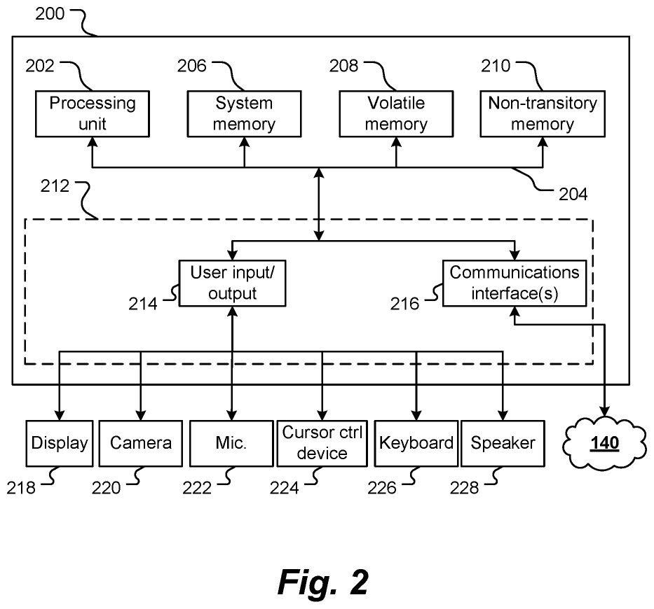

FIG. 2 provides a block diagram of a computer processing system 200 configurable to implement embodiments and/or features described herein. System 200 is a general purpose computer processing system. It will be appreciated that FIG. 2 does not illustrate all functional or physical components of a computer processing system. For example, no power supply or power supply interface has been depicted, however system 200 will either carry a power supply or be configured for connection to a power supply (or both). It will also be appreciated that the particular type of computer processing system will determine the appropriate hardware and architecture, and alternative computer processing systems suitable for implementing features of the present disclosure may have additional, alternative, or fewer components than those depicted.

Computer processing system 200 includes at least one processing unit 202. The processing unit 202 may be a single computer processing device (e.g. a central processing unit, graphics processing unit, or other computational device), or may include a plurality of computer processing devices. In some instances, where a computer processing system 200 is described as performing an operation or function all processing required to perform that operation or function will be performed by processing unit 202. In other instances, processing required to perform that operation or function may also be performed by remote processing devices accessible to and useable (either in a shared or dedicated manner) by system 200.

Through a communications bus 204 the processing unit 202 is in data communication with a one or more machine readable storage (memory) devices which store computer readable instructions and/or data which are executed by the processing unit 202 to control operation of the processing system 200. In this example system 200 includes a system memory 206 (e.g. a BIOS), volatile memory 208 (e.g. random access memory such as one or more DRAM modules), and non-transitory memory 210 (e.g. one or more hard disk or solid state drives).

System 200 also includes one or more interfaces, indicated generally by 212, via which system 200 interfaces with various devices and/or networks. Generally speaking, other devices may be integral with system 200, or may be separate. Where a device is separate from system 200, the connection between the device and system 200 may be via wired or wireless hardware and communication protocols, and may be a direct or an indirect (e.g. networked) connection.

Generally speaking, and depending on the particular system in question, devices to which system 200 connects include one or more input devices to allow data to be input into/received by system 200 and one or more output device to allow data to be output by system 200.

By way of example, where system 200 is a personal computing device such as a desktop or laptop device, it may include a display 218 (which may be a touch screen display and as such operate as both an input and output device), a camera device 220, a microphone device 222 (which may be integrated with the camera device), a cursor control device 224 (e.g. a mouse, trackpad, or other cursor control device), a keyboard 226, and a speaker device 228.

As another example, where system 200 is a portable personal computing device such as a smart phone or tablet it may include a touchscreen display 218, a camera device 220, a microphone device 222, and a speaker device 228.

As another example, where system 200 is a server computing device it may be remotely operable from another computing device via a communication network. Such a server may not itself need/require further peripherals such as a display, keyboard, cursor control device etc. (though may nonetheless be connectable to such devices via appropriate ports).

Alternative types of computer processing systems, with additional/alternative input and output devices, are possible.

System 200 also includes one or more communications interfaces 216 for communication with a network, such as network 140 of environment 100 (and/or a local network within the server environment 110). Via the communications interface(s) 216, system 200 can communicate data to and receive data from networked systems and/or devices.

System 200 stores or has access to computer applications (which may also referred to as computer software or computer programs). Generally speaking, such applications include computer readable instructions and data which, when executed by the processing unit 202, configure system 200 to receive, process, and output data. Instructions and data can be stored on non-transitory machine readable medium such as 210 accessible to system 200. Instructions and data may be transmitted to/received by system 200 via a data signal in a transmission channel enabled (for example) by a wired or wireless network connection over an interface such as communications interface 216.

Typically, one application accessible to system 200 will be an operating system application. In addition, system 200 will store or have access to applications which, when executed by the processing unit 202, configure system 200 to perform various computer-implemented processing operations described herein. For example, and referring to the networked environment of FIG. 1 above, server environment 110 includes one or more systems which run a server application 114. Similarly, client system 130 runs a client application 132.

In some cases, part or all of a given computer-implemented method will be performed by system 200 itself, while in other cases processing may be performed by other devices in data communication with system 200.

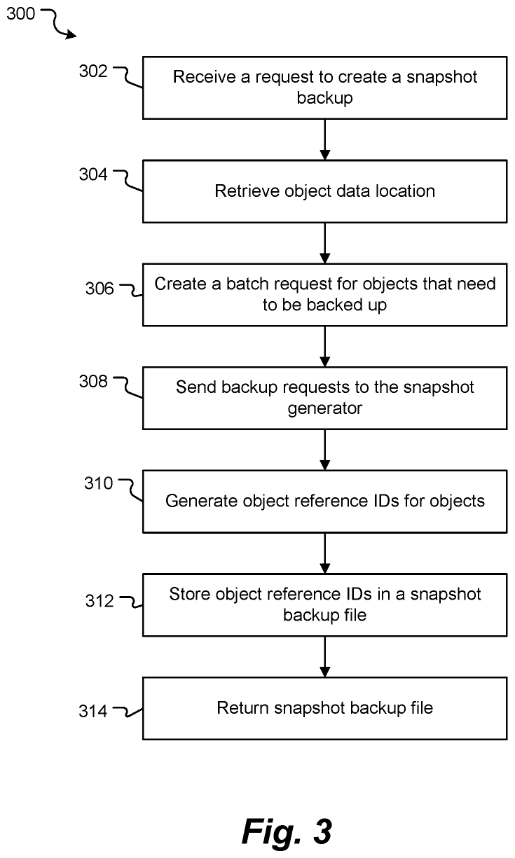

FIG. 3 is a flowchart depicting an example method for generating a backup snapshot according to embodiments of the present disclosure.

The method 300 commences at step 302 where the backup manager 120 receives a request to create a backup. The request may be generated manually or automatically. For example, a user of the client application 132 may manually submit a request for a backup, e.g., via a suitable user interface for creating backups provided by the client application 132. Alternatively, the client application 132 may be scheduled to generate backup requests (e.g., periodically and/or in response to certain trigger events). In any event, the client application 132 generates the backup request and communicates it to the backup manager 120 through communication network 140.

Alternatively, the request may be initiated automatically by server environment 110. For example, server environment may generate a request to create a backup snapshot either periodically or in a scheduled manner.

In some embodiments, the backup request includes information identifying the client/tenant requesting the backup, a time for which backup is requested, and/or information including the data to be backed up. For example, in the case of a project management tool, a tenant may have multiple project management boards maintained at the project management server. It may request a backup of multiple boards or one or more specific boards. Similarly, a tenant may host all their documents/media items in a cloud-based work management application and may request backup of documents/media items in certain folders/portions of the data or a backup of all the documents/media items maintained by the work management application. In another example, the tenant may request backup for a complete website.

At step 304, the backup manager 120 receives the backup request and parses the request to identify information in the backup request that can be used to identify the location of the data objects associated with the request. If the tenant identifier is provided, the backup manager 120 utilizes the tenant identifier to query data storage 118 and retrieves the location of the corresponding tenant data. That is, it performs a lookup in data storage 118 using the tenant identifier to retrieve, e.g., the shard and partition identifiers of the object store 140 where the tenant data is stored.

In some embodiments, the tenant data (i.e., source partition ID and source shard ID) may be stored locally on client device 130 or client application 132. In such cases, the backup request includes this information. Accordingly, in such cases, a lookup in the data store 118 is not required. In still other embodiments, where the server application 114 includes a tenant management system, backup manager 120 may instead query the tenant management system for the source shard and partition ID based on the tenant identifier provided in the backup request.

It will be appreciated that if the backup request includes information about the portion of the tenant data to be backed-up (e.g., identifiers of webpages, project boards, and/or workspaces to be backed up), the location of that specific portion of tenant data is identified at step 304.

At step 306, the backup manager 120 identifies the data objects to be backed up. To this end, it queries the data store 118 with the information about the data to be backed up in the backup request. For example, it may query the data store 118 to provide a list of identifiers of data objects in a workspace, folder, instance, website, etc., that is required to be backed up. The data store 118 returns the list of data object identifiers—e.g., mediaIDs.

Once the backup manager 120 identifies the data objects that need to be backed-up, it creates an object request for each data object to be sent to snapshot generator 122 (step 308). Each object request includes the corresponding object's identifier (e.g., mediaID). The object requests may be combined to create a single batch request, which may be sent as a single request to the snapshot generator 122. In some embodiments, there may be more than one batch request.

Upon receiving the object requests, the snapshot generator 122 initiates a query to the data store 118 to retrieve the object store identifiers for the data object in each request. To this end, the snapshot generator 122 provides the mediaID in an object request to the data store 118, which may perform a lookup in the identifier relational table to retrieve the object store identifier (e.g., objectstoreID) for that mediaID.

Once the snapshot generator 122 obtains the objectstoreIDs for each of the data objects, it requests the object store manager 126 to create object reference identifiers for each of the data objects. The request includes the objectstoreIDs of each of the data objects.

At step 310 the object store manager 126, for each objectstoreID generates a unique object reference ID (objectRefId). To do so, the object store manager 126 queries the object store 140 to retrieve metadata associated with the data object. The metadata may include information such as time at which the data object was last updated, viewed, etc., the version number of the data object, the OS identifier, the author, etc. Using at least a portion of this metadata, the object store manager generates the object reference identifier. The generated object reference identifiers are communicated back to the snapshot generator 122.

Generally speaking, the objectRefId contains a reference to a specific version of the data object stored in object store 140. For example, the objectRefId may be a concatenation of objectstoreID and the latest version of the data object. In some embodiments, the objectRefId further includes the mediaID.

In some cases, the object store 140 may retain data objects deleted by the tenant. The data objects are “soft deleted” in the object store 140 for a particular period of time—e.g., 30 days before they are hard or permanently deleted. Soft deleted data objects are flagged to indicate deletion. In such cases, before generating the object reference, the object store manager 126 checks the state of the given object and creates the object reference if it is determined that the state of the object is active. For example, object store 140 may check whether the data object has a flag indicating deletion. if the data object does not include such a flag, an objectRefId is created for the data object. Otherwise (if the data object includes a soft deletion flag), the objectRefId is not created.

In some embodiments, the request to create the objectRefId will also set a time-to-live value. The time-to-live value specifies the duration until the object reference expires and becomes invalid for restoring. In some embodiments, the time-to-live (TTL) value will have a default value. For example, the default value may be 30 days.

At step 312, the snapshot generator 122 stores the objectRefIds and the TTL values in a backup snapshot file. For example, the backup snapshot file may be a JSON file containing mediaIDs and the corresponding objectRefIds of the data objects for which objectRefIds were created. In some embodiments, the backup snapshot file may also store the source location of the data objects (e.g., the object store shard and/or partition IDs where the data objects are stored).

At step 314, after creating the backup snapshot file, the snapshot generator 122 communicates successful completion of the backup file to the backup manager 120. The backup manager 120 can then notify the client application 132 that the requested backup snapshot has been successfully created. In some cases, the snapshot generator 122 communicates the backup file to the backup manager 120 and the backup manager 120 communicates the backup file to the client application 132 that requested the backup. In this manner, the backup snapshot file may be downloaded and saved directly on the client device 130 through the client application 132. Alternatively, the snapshot generator 122 may store the backup file in the data storage 118, associated with the relevant tenant data at this step and only provide a notification that the backup file has been created and saved.

FIG. 4 is a flowchart depicting an example method for restoring a backup based on a backup snapshot. The backup snapshot may be for example, the backup snapshot file created in method 300. Whilst the present disclosure refers to method 400 as restoring a backup, it will be appreciated that restoring may also refer to restoring the backup as a copy. Generally, in method 400, the backup manager 120 downloads the object binary linked to a corresponding reference identifier in the backup file and subsequently uploads the object binary into a new location (e.g., a new partition in the object store 140).

The method 400 commences at step 402, where a request to restore a backup snapshot is received by the backup manager 120. In some embodiments, the restore request is initiated by client application 132. In other cases, it might be initiated by another server application.

In some examples, the backup snapshot file is provided in the request. In other examples, the backup manager 120 retrieves the backup snapshot file from the data store 118 (e.g., using a file identifier provided in the request).

In some examples, the request also provides a target site to restore the backup. The target site identifying a place accessible by the client application, to restore the backup. For example, the target site may be a specific URL.

On receiving the restore request, the backup manager 120 identifies the target location in the object store 140 for the target site. For example, where the request to restore a backup snapshot includes an existing target site, the backup manager may identify the target partition associated with the target site. On the other hand, where a target site is not provided, the backup manager 120 may send a request to object store manager 126 to create a new partition on object store 140 for the backup.

At step 404, the backup manager 120 obtains the object references from the backup snapshot file that need to be restored.

At step 405, it retrieves an unprocessed objectRefId and sends a request to the snapshot restorer 124 to obtain the object binary for that data object using the objectRefId. The request includes the objectRefId. It also includes identifiers of the source location (e.g., source partition and shard IDs retrieved from the backup snapshot file). and the target location (e.g., target partition and shard IDs identified in the previous step) where the data object is to be copied.

The snapshot restorer 124 receives this request and communicates a request for the object binary to the object store manager 126.

At step 406, the object store manager 126 checks whether the request to restore the backup snapshot is authorised. In particular, the object store manager 126 queries the backup manager 120 to determine whether the restoration of the backup snapshot from the source partition to the target partition is allowed. This check is performed to ensure that a malicious party is not trying to restore a backup for another tenant.

In response, the backup manager 120 checks whether the backup request is legitimate and either provides authorization to the object store manager 126 (if the request is determined to be legitimate) or denies authorization to the object store manager 126 (if the request is determined to be illegitimate). In one example, to determine the legitimacy of the backup request, the backup manager 120 checks the tenant ID that is associated with the request to restore a backup snapshot and determines if the target location (e.g., partition ID) is associated with that tenant ID. If the backup manager 120 determines that the target location and the tenant ID are associated, it authorizes the request. Conversely, if the target location and the tenant ID are not associated, the request is denied.

At step 408, if the object store manager 126 determines that the backup request is authorized (e.g., because it receives a confirmation from the backup manager 120), the object manager 126 retrieves the object binary from the object store 140 and communicates it to the snapshot restorer 124.

At step 410, the snapshot restorer 124 creates a new unique mediaID for the restored data object. The new mediaID identifies the restored object on the new instance of the application or workspace created by the backup snapshot. It also communicates an upload request to the object store manager 126 along with the object binary and the target location. The object store manager 126 receives the upload request and communicates with the object store 140 to upload the object binary at the target location (e.g., target partition).

At step 412, the object binary is uploaded to the target partition. The object store manager 126 communicates to the snapshot restorer 124 that the object binary has been successfully uploaded.

The method then proceeds to step 413, where a determination is made whether any unprocessed ObjectRefIds remain. If it determines that one or more unprocessed objectRefIds remain, the method reverts to step 405 and method steps 405-412 are repeated. Otherwise, the method 400 ends. Once the data objects have been processed, the backup manager 120 communicates to the client application 132 that the restoration of the backup snapshot has been successful.

FIG. 5 is a flowchart of another example method for restoring a backup based on a backup snapshot. The backup snapshot may be for example, the backup snapshot file created in method 300. Method 500 may be used instead of method 400 to eliminate the need for downloading and uploading object binaries whilst restoring a backup snapshot in method 400. In some embodiments, this may result in a faster restore process and reduce load on the computer system. The method 500 may also ensure that the object binaries and other metadata remain in the object store 140 improving the security of the restoration process as the object binaries do not leave the storage system. Whilst the present disclosure refers to method 500 as restoring a backup, it will be appreciated that restoring may also refer to restoring the backup as a copy.

The method 500 commences at step 502, where a request to restore a backup snapshot is received by the backup manager 120. This step is similar to step 402 and therefore is not described in detail here.

On receiving a request to restore a backup, the backup manager 120 selects or creates a target partition in object store 140. This step is also similar to that described with reference to FIG. 4 and therefore is not described here in detail again.

At step 504, the backup manager 120, checks whether the source location and the target location are in the same region. If the source and target locations are in the same region in the object store, the binary data for the data objects is available in that region in the source location and does not therefore need to be copied to the target location. Instead, the binary data can be directly accessed from the source location. Where the object store 140 maintains different shards for different regions, this check involves determining whether the target partition is in the same shard in object store 140 as the source partition.

If the backup manager 120 determines that the source and target locations are in the same region, the method proceeds to step 505, where the backup manager 120 selects an unprocessed objectrefId from the backup snapshot file. Otherwise, the method 500 ends at this step.

For the selected objectRefId, at step 506, the backup manager 120 creates a new mediaID. The new mediaID identifies the object in the target partition. In some embodiments, the new mediaID will be unique identifier. The newly created mediaID (target mediaID) is mapped to the original mediaID (source media ID). For example, the backup manager 120 may maintain a database in data store 118 that includes the relationship between the source and target media IDs. The source media ID is retrieved from the backup file for this purpose.

Next, at step 508, backup manager 120 sends a request to the snapshot restorer 124 to restore the object at the target destination. The request includes the objectRefId of the data object. The snapshot restorer 124 then communicates with object store manager 126 to initiate the restoration of the data object from the backup snapshot file to the target partition.

In particular, at step 510, the object store manager 126 determines whether the request to restore the object is authorised. This step is similar to step 406 of method 400 and therefore is not described again.

Once, the object store manager 126 determines that the restoration is authorized, at step 512, the object store manager 126, creates the target object in the target partition. It also determines the source objectstoreID and version number from the objectRefId. Using this information, it initiates a copy request for that object from the source partition to the target partition.

In some embodiments, upon providing the objectstoreID and version number to object store 140, the object store 140 creates a new object in the target location which mirrors the original data object's content and its state at the point of reference creation. The new object binary created by this restoration process becomes the most recent version of that object.

In some cases, the new objectStoreId may already exists at the target location. This may happen if the target destination is the same as the source destination. In such cases, the restore operation overwrites that object with the one created from the object reference. This effectively results in soft deletion of the most recent version of the object that existed before the restoration.

In some embodiments, a new time-to-live (TTL) may be specified in the request to restore an object. In such cases the restored object will adopt that TTL for setting an expiry. If no TTL is provided, the restored object will not be assigned any expiry, even if the original object was initially uploaded with a TTL value.

The object store manager 126, then communicates to backup manager 120 that the object has been successfully restored.

The method then proceeds to step 513, where a determination is made whether any unprocessed ObjectRefIds remain. If the backup manager 120 determines that one or more unprocessed objectRefIds remain, the method reverts to step 505. Otherwise, the method 500 ends. Once all the objectRefId are processed, the backup manager 120 communicates to the client application 132 that the restoration of the backup snapshot is successful.

The flowcharts illustrated in the figures and described above define operations in particular orders to explain various features. In some cases the operations described and illustrated may be able to be performed in a different order to that shown/described, one or more operations may be combined into a single operation, a single operation may be divided into multiple separate operations, and/or the function(s) achieved by one or more of the described/illustrated operations may be achieved by one or more alternative operations. Still further, the functionality/processing of a given flowchart operation could potentially be performed by different systems or applications.

Unless otherwise stated, the terms “include” and “comprise” (and variations thereof such as “including”, “includes”, “comprising”, “comprises”, “comprised” and the like) are used inclusively and do not exclude further features, components, integers, steps, or elements.

It will be understood that the embodiments disclosed and defined in this specification extend to alternative combinations of two or more of the individual features mentioned in or evident from the text or drawings. All of these different combinations constitute alternative embodiments of the present disclosure.

The present specification describes various embodiments with reference to numerous specific details that may vary from implementation to implementation. No limitation, element, property, feature, advantage, or attribute that is not expressly recited in a claim should be considered as a required or essential feature. Accordingly, the specification and drawings are to be regarded in an illustrative rather than a restrictive sense.

1. A computer implemented method including:
receiving a request to backup a set of data objects, the set of data objects including at least a first data object and a second data object;
generating object reference identifiers for the set of data objects, wherein generating the object reference identifiers includes:
determining a first object identifier of the first data object in an object store where the first data object is stored;
retrieving metadata associated with the first data object based on the first object identifier;
generating a first object reference using the first object identifier and the metadata associated with the first data object;
determining a second object identifier of the second data object in the object store where the second data object is stored;
retrieving metadata associated with the second data object based on the second object identifier;
generating a second object reference using the second object identifier and the metadata associated with the second data object;
storing a location of the first and second data objects in the object store along with the first object reference and the second object reference in a backup file; and
communicating the backup file to a client application associated with the backup request.

2. The computer implemented method of claim 1, further comprising:
determining a first media identifier associated with the first data object, wherein the first media identifier is different from the first object identifier;
determining a second media identifier associated with the second data object, wherein the second media identifier is different from the second object identifier; and
adding the first media identifier and the second media identifier in the backup file.

3. The computer implemented method of claim 1, wherein the location of the first and second data objects includes a partition identifier and a shard identifier in the object store.

4. The computer implemented method of claim 1, wherein the metadata associated with the first and second data object includes a version identifier indicating a latest version of the first and second data objects.

5. The computer implemented method of claim 1 further including:
prior to generating the first object reference, determining that the first object identifier corresponds to an active data object;
prior to generating the second object reference, determining that the second object identifier corresponds to an active data object;
refraining from generating the first object reference in response to determining that the first object identifier corresponds to an inactive data object; and
refraining from generating the second object reference in response to determining that the second object identifier corresponds to an inactive data object.

6. The computer implemented method of claim 1, wherein generating the first and second object references further includes setting a time-to-live value to specify a duration for which the corresponding first and second object references are valid.

7. The computer implemented method of claim 6, wherein the time-to-live value is 30 days.

8. The computer implemented method of claim 1, wherein communicating the backup file to the client application further includes providing a notification to the client application that the backup file has been created.

9. A computer implemented method comprising:
receiving a request to restore a backup at a target site, the request comprising a backup file, wherein the backup file includes at least a first object reference and a second object reference associated with first and second data objects to be restored, and a source location of the first and second data objects;
restoring the first data object at a target location in an object store that is associated with the target site, wherein the restoring includes:
creating a first object identifier based on the first object reference; and
creating the first data object with the first object identifier at the target location;
restoring the second data object at the target location in the object store, wherein the restoring includes:
creating a second object identifier based on the second object reference; and
creating the second data object with the second object identifier at the target location.

10. The computer implemented method of claim 9,
wherein creating the first object with the first object identifier includes:
determining a source location of a first object binary of the first object based on the source location of the first data object;
copying the first object binary from the source location to the target location in the object store;
wherein creating the second object with the second object identifier includes:
determining a source location of a second object binary of the second object based on the source location of the second data object; and
copying the second object binary from the source location to the target location in the object store.

11. The computer implemented method of claim 10, wherein:
the target location includes a target partition identifier and a target shard identifier in the object store; and
the source location includes a source partition identifier and a source shard identifier in the object store.

12. The computer implemented method of claim 9, further including restoring the first data object and the second data object in the target location upon determining whether the request to restore the backup at the target site is authorised.

13. The computer implemented method of claim 12, wherein determining that the request to restore the backup at the target location is authorised includes:
determining a tenant ID associated with the restore request; and
determining that the target site is associated with the tenant ID.

14. The computer implemented method of claim 9, further including restoring the first data object and the second data object in the target location upon determining that the source location and the target location are located in the same region.

15. The computer implemented method of claim 9, wherein creating the second object with the second object identifier further includes:
determining whether the second object identifier already exists in the target location; and
upon determining that the second object identifier already exists in the target location, replacing an existing object binary corresponding to the already existing second object identifier with the second object binary.

16. The computer implemented method of claim 9, wherein the first and/or second object references include a time-to-live value and; wherein prior to restoring the first and/or second objects at the target location, determining that the time-to live value has not been exceeded.

17. The computer implemented method of claim 9,
wherein creating the first object with the first object identifier includes:
determining a source location of a first object binary of the first object based on the source location of the first data object;
downloading the first object binary from the source location in the object store;
uploading the first object binary to the target location in the object store;
wherein creating the second object with the second object identifier includes:
determining a source location of a second object binary of the second object based on the source location of the second data object;
downloading the second object binary from the source location in the object store; and
uploading the second object binary to the target location in the object store.

18. A computer processing system, comprising:
one or more computer processing units; and
a non-transitory computer-readable medium storing instructions which, when executed by the one or more computer processing units, cause the one or more computer processing units to:
receive a request to backup a set of data objects;
generate object reference identifiers for the set of data objects, wherein generating the object reference identifiers includes for each data object in the set of data objects:
determine an object identifier of the data object associated with an object store where the data object is stored;
retrieve metadata associated with the data object based on the object identifier;
generate an object reference using the object identifier and the metadata associated with the data object;
store a source location of the set of data objects in the object store along with the generated object references in a backup file; and
communicate the backup file to a client application associated with the backup request.

19. A non-transitory storage storing instructions executable by one or more computer processing units to cause the one or more computer processing units to:
receive a request to restore a backup at a target site, the request comprising a backup file, wherein the backup file includes a set of object references associated with a set of data objects to be restored, and a source location of the set of data objects;
determining whether a target location in an object store that is associated with the target site is in a same region as the source location of the set of data objects; and
upon determining that the target location is in the same region as the source location:
restoring the set of data objects at the target location, wherein the restoring includes:
creating object identifiers based on the object references of the set of data objects; and
copying the set of data objects from the source location to the target location and associating the copied data objects with the object identifiers of the set of data objects.
